(19) United States
(12) Patent Application Publication
(10) Pub. No.: US 2017/0275473 A1
(43) Pub. Date: Sep. 28, 2017

(54) COMPOSITIONS AND METHOD FOR INHIBITING BIOFOULING AND BARNACLE GROWTH ON SUBSTRATES UNDER WATER

(71) Applicant: Carl G. Cabot, JR., Bentonville, AR (US)

(72) Inventor: Carl G. Cabot, JR., Bentonville, AR (US)

(21) Appl. No.: 15/407,243

(22) Filed: Jan. 16, 2017

Related U.S. Application Data
(60) Provisional application No. 62/256,017, filed on Nov. 16, 2015.

(51) Int. Cl. C09D 5/16; B05D 3/02; B63B 59/04; C09D 7/12

(52) U.S. Cl. CPC C09D 5/1625; C09D 7/1233; B05D 3/0254; B63B 59/04

(57) ABSTRACT

The invention provides a marine antifouling composition comprising: (a) 1 to 50% by weight of a cylic volatile methylsiloxane selected from the group consisting of hexamethylcyclotrisiloxane, octamethylcyclotetrasiloxane, decamethylcyclopenta-siloxane and dodeca-methylcyclohexasiloxane; (b) 1 to 20% of a surfactant selected from the group consisting of polyoxyethylene monostearate, steareth-40, octylphenoxy polyethoxyethanol, steareth-20, and a C₁₁-C₁₅ secondary alcohol ethoxylate; and (c) the balance water.

### FIELD OF INVENTION

The present invention relates to an antifouling coating composition that has long-term storage stability and gives a coating film exhibiting excellent antifouling properties and water resistance (long-term mechanical properties); an antifouling coating film formed therefrom and an antifouling substrate having such a coating film; and antifouling substrate production method.

The present invention also generally relates to marine coating compositions comprising components that provide antifouling properties. The instant invention also relates to method for inhibiting and preventing barnacles and other marine life from attaching to the hull of a boat. This invention further relates generally to coatings used to protect underwater surfaces from settlement by aquatic organisms, and more specifically relates to the inclusion of polymethylcyclosiloxanes in such a coating. This invention further relates to the hydrophobic properties to aid in the reduction in slip-co efficiency for better fuel millage reduced drag.

The present invention also features coating compositions which provide protection to surfaces coated therewith from attachment of various biofouling organisms. The instant invention to coating cycloorganosiloxane compositions which can be applied to marine structures. The compositions provide a biofouling resistant coating on the surface of the marine substrates which prevents underwater organisms from adhering and growing on the surfaces of the substrates over a period of time.

### BACKGROUND OF THE INVENTION AND DESCRIPTION OF THE PRIOR ART

The surfaces of substrates such as ships, underwater structures and fishing nets that are exposed to water for a long term easily undergo the adherence thereto of various aquatic creatures including animals such as oyster, mussel and barnacle, plants such as layer, and bacteria. The propagation of these aquatic creatures on the substrate surfaces would cause various problems: where the substrate is a ship, for example, the surface roughness increases from the waterline to the bottom of a ship, resulting in the decrease in the speed of a ship and increase in fuel cost of a ship. Where the substrate is a fishing net such as a culturing net and a fixed net, the clogging of the mesh by aquatic creatures could cause serious problems such as the death of cultured creatures and caught fish because of oxygen deficiency. Where the substrate is a water supply and exhaust pipe for seawater of e.g., a thermal power plant and a nuclear power plant, it may happen that the water supply and exhaust pipe for seawater (cooling water) is clogged or flow rate is decreased to disturb circulation systems.

A large number of organisms such as barnacles, bacterial slimes, ascidians, serupulas, fresh- and salt-water mussels, polyzoan, green algae, sea lettuce and the like live in the waters of the sea, rivers, lakes and swamps. The organisms responsible for fouling can be classified into two major categories. Shelled organisms, also referred to as “hard-fouling” types, include barnacles, tube worms, encrusting bryozoans and mollusks. Organisms without a shell, referred to as “soft-fouling” types, include algae such as seaweed, tunicates, filamentous bryozoans, and hydroids. These plants and animals cause various types of damages, and particularly adhere to and degrade many underwater structures. Fouling of a ship's hull by any of the aforementioned organisms is most undesirable since it increases both fuel consumption and maintenance costs resulting from the frequent dry docking required to clean and repair the submerged portions of the hull.

The problem of barnacles attaching themselves to the hull of a boat has plagued man for centuries. One solution to this problem is of course to remove the boat from the water after each use; however this is very expensive and impractical and besides barnacles, though to a much lesser degree, can also grow on an object moving in the water. Marine organisms such as algae, mollusks, tubeworms and barnacles attach to the surfaces of structures submerged in seawater, oceans, rivers and lakes. This marine growth on these surfaces may affect the integrity of the structure (e.g., ships, boats, pilings, water intake and outfall pipes) and can seriously hamper the operation of these systems. For example, on ship hulls the attachment of marine growth adversely affects the speed of the ship and its fuel efficiency due to the increased drag caused by the marine growth. For water intakes, there is an attendant loss of cooling efficiency in power generation and manufacturing process operation when such intakes have significant marine growth attached.

Along the coasts of the North Atlantic Ocean, barnacles and different kinds of algae are particularly apparent problems. The fully grown barnacle is a stationary crustacean (arthropod), characterized by a centimeter-sized cone shape and enclosing layers of calcinous plates. The mechanical strength of the animal's attachment to solid surfaces is very high, and it is therefore difficult to mechanically remove barnacles from solid surfaces. The animal undergoes different development stages as free-swimming larvae, where the last larva stage is referred to as the cyprid stage. The cyprid screens solid surfaces suitable for settling with the help of a nervous protuberance, the antennule. A “settling-glue” referred to as balanus cement is secreted from specialized glands localized near the protuberance and the animal thereby settles to the solid surface. After settlement the animal undergoes a metamorphosis into an adult and stationary animal.

The common name oyster is used for a number of different groups of bivalve mollusks, most of which live in marine habitats or brackish water. The shell consists of two usually highly calcified valves which surround a soft body. Gills filter plankton from the water, and strong adductor muscles are used to hold the shell closed. Oysters are a biofouling species. The pediveliger larva is last larval stage of an oyster in which the veliger larva (characterized by a ciliated lobe (or lobes) known as the velum which functions in propulsion and food-gathering) develops a foot and seeks a substrate on which to settle. The settling and cementation process leads to biofouling of the substrate.

It has been common practice to coat the substrate surfaces of wood, plastic and metal with coating compositions that inhibit attachment and/or growth of marine organisms. Such coating compositions are usually referred to as antifoulant coatings or antifoulant paints and generally consist of a binder material, an antifouling agent (biocides and “booster biocides”), diluents and additives to aid in adhesion, flow, color, viscosity, stability, etc.

Special paints for the hulls of boats have been developed to prevent barnacles and other marine life from attaching to the hull, these paints function by poisoning the life forms that come in contact with them. There is a concern for the possible effects of antifoulant compounds on the environment. One approach is the development and use of systems which attempt to control fouling through surface modification; for example, preventing attachment of algae and barnacles through the use of polymers having non-stick or release properties. Another approach is to use antifouling compounds that are toxic enough to marine life so that marine structures are not significantly fouled, but have a toxicity such that generally marine life is not harmed nor irreversibly altered. In this context, it is preferred that the compounds used as antifouling agents do not build up in the environment and cause deformation or adverse changes in marine life. It is desirable, for example, to provide antifouling agents that are less toxic than tributyltin (TBT) that has been used as an antifouling agent for many years and is now officially banned in some waters due to the harm to marine life that resulted from TBT leaching into the waters. In addition, TBT has caused deformations in oysters to develop thick shells and sex-changing disorders in whelks among other biological changes noted from its use.

Apparently anti-fouling paint functions by leaching toxic chemicals into the water surrounding a boat thus repelling the growth of barnacles as well as other forms of marine life. However the use of this paint obviously creates an environmental hazard affecting fish-life and in turn fish food and humans due to the toxicity of tin. Several states have now banned the use of T.B.T. as an anti-fouling agent and other countries of the world have joined in a similar ban.

It is understood by those of skill in the art that a marine coating must be water resistant in order to provide practical and effective protection. The expression “water resistant,” as used in describing the composition of the invention, refers to its ability to provide a durable, protective barrier that can effectively withstand hydrolytic attack and is essentially impermeable to water. Water resistance is intrinsically important to marine coatings because, for example, it is prohibitively expensive to re-coat most items in marine service, as they must be put into dry-dock or otherwise removed from the water in order to be re-coated. It is also desirable, for example, to minimize the time and expense of cleaning fouling organisms from the coated surface. The protection provided by a marine coating, therefore, whether it be against corrosion, fouling, abrasion, etc., should be effective over a period of at least months, and, ideally, over at least several years. A coating composition that is not water resistant would be short lived in the water rather than meeting the performance criteria of a marine coating.

By way of further background, it is known that maritime vessels require a coating on the submerged section of the vessel to prevent buildup of “sea growth”, including algae, larvae, and spores from marine animals and plants. The accumulation of this type of growth on the vessel results in an increase in friction, i.e., greater surface area, between the hull and the surrounding water. Increased friction will be manifested by slower movement and increased energy consumption to propel the vessel through the water. Buildup of growth on a ship hull occurs most often when the ship is docked or moored, particularly in marinas or ports where water is not moving and thereby containing a higher concentration of marine organisms.

This buildup is obviously undesirable and the coatings normally employed by the industry to reduce or prevent marine life buildup up are called “antifouling paints”. These paints contain inorganic and organic compounds that slowly leach out of the coating into the water surrounding the hull. The active components of the antifouling paints are typically heavy metal sulfides or oxides of nickel, manganese, iron, zinc, cadmium, cobalt, lead and mercury. Organic tins or pesticides are often included within the coating substrate. These heavy metals leach out of the ship coating forming a thin, highly concentrated laminar layer several microns thick surrounding the ship hull. The high percentage of the thousands of types of microorganisms that come in contact with this environment are killed by the complexation of these heavy metals with their proteins and enzymes. Any microorganism or animal that does succeed in attaching to the hull may eventually die after continued exposure to these purported toxins. Over time many of the heavy metals such as tin will hydrolyze and slough off with the top layers of the coating, taking with them any attached dead marine growth. This procedure results in a freshly exposed coating surface with more toxins able to leach from the surface. The antifouling coating must be reapplied new to the hull of a ship at the beginning of every boating season. The effective life of the coating is typically 9 to 12 months.

The problem confronting the industry is that the antifouling paints by the very nature of their efficacy contain materials that are considered to be toxic to the marine environment. Marine organisms and micro-organisms that have died as a result of the interference of these heavy metals with their metabolic pathways will be passed into the food chain in the marine environment.

This problem is most evident in small inlet waterways, lakes and streams where bottom samples and fish samples have shown increasingly high levels of these inorganic materials in recent years. Many of these waterways used for recreational boating activities also serve as reservoirs for potable water. Legislation has been proposed in many countries limiting or banning the use of antifouling paints in freshwater and sweetwater areas.

All maritime paints used as coatings for ship hulls contain these organic and inorganic substances as part of their antifouling mechanisms. Other types of technology have been introduced to reduce marine buildup on piers and oil platform pilings; these silicone rubbers and elastomers although reducing buildup have proved difficult to clean, which make them unusable as coating materials for boats. With the proposed restriction and potential banning on conventional antifouling paints, new technologies must be developed to fulfill the demanding requirements of this application. To date, no viable technologies have been introduced to the market as a potential replacement for inorganic and organic containing antifouling coatings.

Despite the advances made in marine coatings, there exists a need for new marine coatings that offer advantageous properties of nonfouling. The present invention seeks to fulfill this need and provides further related advantages such as a wider variety of environmentally safe and effective antifouling marine coating compositions.

### OBJECTS OF THE INVENTION

The object of the present invention is to provide compositions and methods to prevent fouling and biofouling of substrates placed underwater.

### BRIEF DESCRIPTION OF THE DRAWINGS

FIGS. 1-4 show the effectiveness of the coating composition of the invention when applied to boat hulls and metal substrates.

FIG. 1 shows a coated metal plate with very little pitting or fouling on the surface when compared with the others after 12 months of exposure.

FIG. 2 shows the side of a coated boat with little or no fouling.

FIG. 3 shows another side of the boat with little or no fouling.

FIG. 4 shows the bottom of a boat hull with little or no fouling.

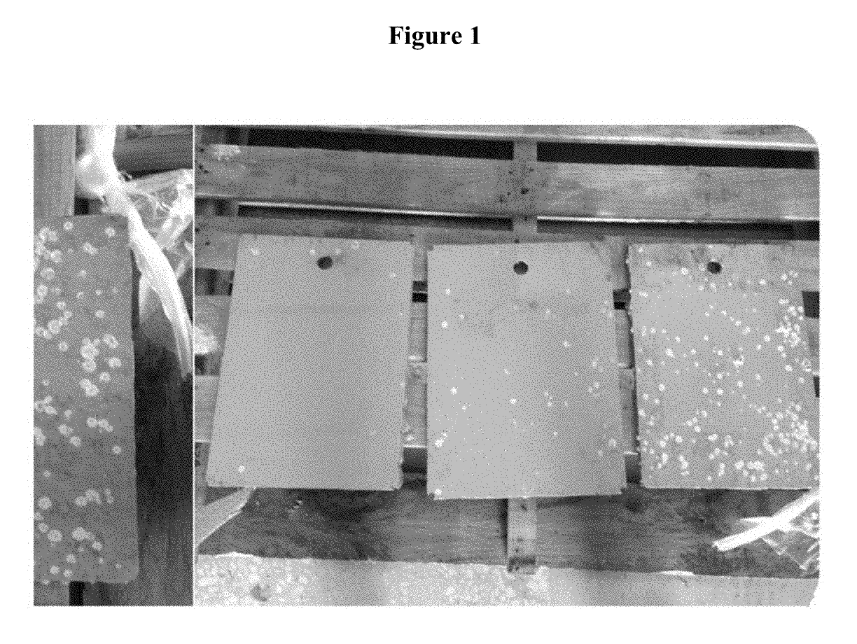

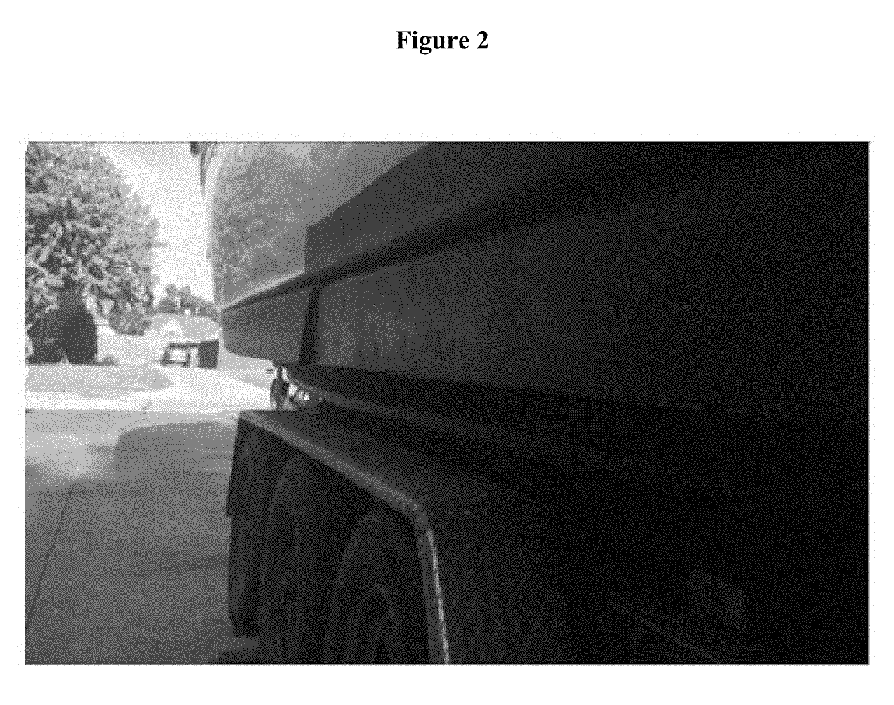

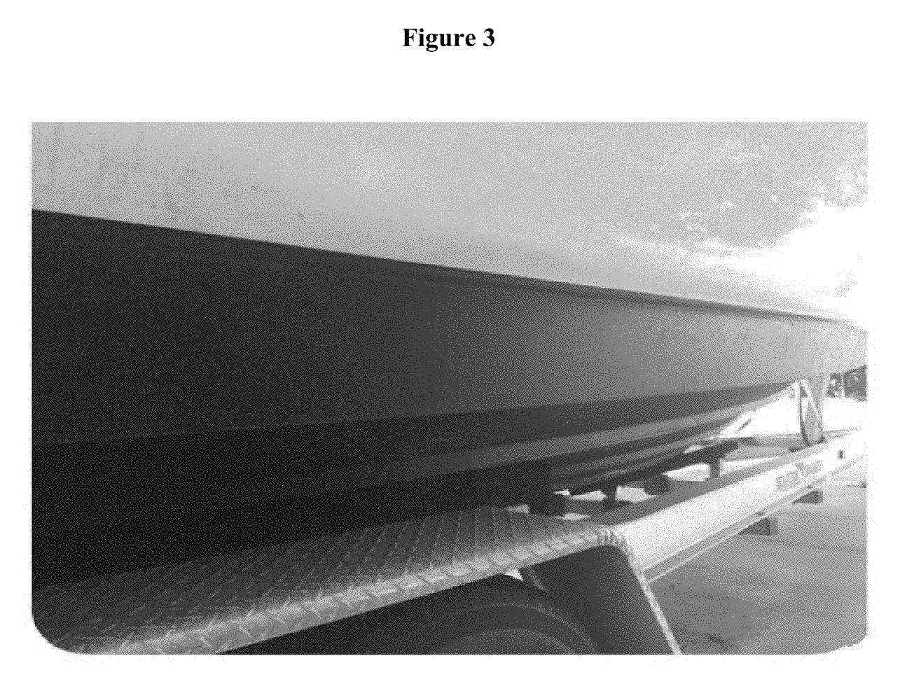

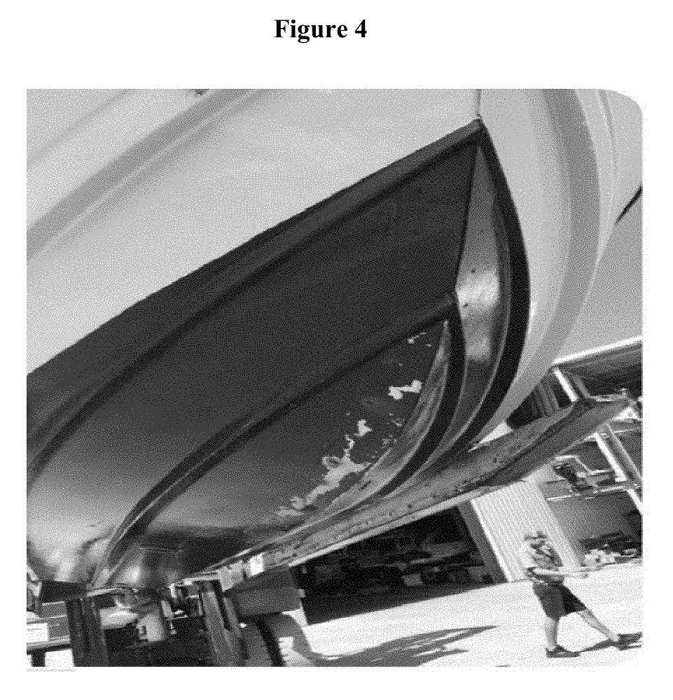

### SUMMARY OF THE INVENTION

The invention provides a marine antifouling hydrophobic film or coating emulsion composition comprising: (a) 1 to 50% by weight of a cylic volatile methylsiloxane selected from the group consisting of hexamethylcyclotrisiloxane, octamethylcyclotetrasiloxane, decamethylcyclopentasiloxane and dodecamethylcyclohexasiloxane and mixtures thereof; and (b) 1 to 20% of a surfactant selected from the group consisting of polyoxyethylene monostearate, steareth-40, octylphenoxy polyethoxyethanol, steareth-20, and a C₁₁-C₁₅ secondary alcohol ethoxylate and mixtures thereof; and (c) the balance water.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE INVENTION

The present invention will be more fully understood by reference to the following description and examples. Variations and modifications of the embodiments of the invention can be substituted without departing from the principles of the invention, as will be evident to those skilled in the art.

The invention provides a method and a marine coating composition for inhibiting biofouling of substrates that are underwater. The marine coatings of the present invention are effective for inhibiting fouling of underwater structures by a variety of organisms. Specifically, they are effective for preventing the attachment and propagation of organisms such as those described below and they provide antifouling properties over a long period of time.

Generally, barnacles, tubeworms, algae, seaweed and brown and red bryozoans are the organisms that cause the greatest concern in salt and brackish waters. Zebra mussels are the organisms that cause the most fouling problems in fresh water of temperate and subtropical areas.

The fouling organisms are those that attach to an aquatic surface. These include, for example, barnacles (members of the class Cirripedia) described below, tubeworms, sea mussels, Zebra mussels, hydroides, ectoprocts, tube-building amphipods, oysters, sea moss, mollusks, shellfish, ulba, enteromorpha, ectocorpus, ostrea, mytilus, ascidian, slime; seaweed and algae such as sea lettuce, green laver, marine spirogyra and red and brown bryozoan. The invention is contemplated to inhibit attachment of additional aquatic organisms which otherwise tend to fix themselves to a submersed surface. These organisms can include fresh and salt water environments and organisms.

Barnacles belong to the phylum Arthropoda, subphylum Crustacea, class Cirripedia. They are exclusively marine and, unlike other crustaceans, are all sessile. There are more than 600 species worldwide, and many are colorful animals, for example, red, orange, purple, pink and striped. The majority are a few centimeters in diameter, with some considerably larger. Most are found in the intertidal zone. Those living in shallow-water communities are either typical fouling balanids or commensals.

Twenty-two species of barnacles are reported in the Indian Ocean. Of these seven are frequently encountered on panels testing the efficacy of antifouling coating as described in Example 2 and harbor installations. They are Balanus amphitrite amphitrite, Balanus amphitrite communis, Balanus uariegatus, Megabalanus antillensis, Chthamalus malayensis, Chthamalus withersi, and Lapas anatifera. All these species have broad geographic ranges. All Chthamalus species, Lepas species, and B. amphitrite prefer waters of near normal salinities.

Marine algae vary in size from one-celled organisms a few millimeters in diameter to highly organized plants attaining a length of 30 meters. All algae capable of photosynthetic activity contain the pigment chlorophyll, which is enclosed in cell inclusions called chloroplasts.

A single algal cell may contain one or more chloroplasts. Micro algae (diatoms) are major components of films formed on the surface of a marine structure as it becomes fouled and may play a role in the ecology of these films.

Diatoms belong to the class Bacillariophyceae. A major characteristic of many benthic diatoms is their ability to become permanently attached to surfaces. This is important both ecologically and economically as diatoms constitute at least a portion of the organisms that foul marine structures. For example, diatoms of the following genus (Dunaliella, Nitzschia, Skeletonema, Chaetoceros) and species (Dunaliella tertiolecta, Skeletonema costatum) are important to control.

An underwater marine structure can be any surface that is in contact with fresh, salt, estuarine, brackish, sea or other bodies of water including, for example, ship surfaces (e.g., ship hulls, boat hulls, submarine hulls, propellers, rudders, keels, centerboards, fins, hydrofoils), deck surfaces, buoys, piers, wharves, jetties, fishing nets, cooling system surfaces, cooling water intake or discharge pipes, nautical beacons, floating beacons, floating breakwaters, docks, pipes, pipelines, tanks, water pipes in power stations, seaside industrial plants, fish preserving structures, aquatic constructions, port facilities, bridges, bells, plumbs, wheels, cranes, dredges, pipes, pumps, valves, wires, cables, ropes, ladders, pontoons, transponders, antennae, barges, periscopes, snorkels, gun mounts, gun barrels, launch tubes, mines, torpedoes and depth charges.

The term “substrate” is intended to mean a solid material onto which the coating composition is applied. The substrate typically comprises a metal such as steel, metal alloys, iron, aluminium, or glass-fibre reinforced polyester. In the most interesting embodiments, the substrate is a metal substrate or an alloy metal, in particular a steel substrate. In an alternative embodiment, the substrate is a glass-fibre reinforced polyester substrate. In some embodiments, the substrate is at least a part of the outermost surface of a marine structure.

The term “surface” is used in its normal sense, and refers to the exterior boundary of an object. Particular examples of such surfaces are the surface of marine structures, such as vessels (including but not limited to boats, yachts, motorboats, motor launches, ocean liners, tugboats, tankers, container ships and other cargo ships, submarines, and naval vessels of all types), pipes, shore and off-shore machinery, constructions and objects of all types such as piers, pilings, bridge substructures, water-power installations and structures, underwater oil well structures, nets and other aquatic culture installations, and buoys, etc.

The surface of the substrate may either be the “native” surface (e.g. the steel surface). However, the substrate is typically coated, e.g. with an anticorrosive coating and/or a tie coat, so that the surface of the substrate is constituted by such a coating. When present, the (anticorrosive and/or tie) coating is typically applied in a total dry film thickness of 100-600 μm, such as 150-450 μm, e.g. 200-400 μm. Alternatively, the substrate may carry a paint coat, e.g. a worn-out fouling release paint coat, or similar.

In one important embodiment, the substrate is a metal substrate (e.g. a steel substrate) coated with an anticorrosive coating such as an anticorrosive epoxy-based coating, e.g. cured epoxy-based coating, or a shop-primer, e.g. a zinc-rich shop-primer. In another relevant embodiment, the substrate is a glass-fiber reinforced polyester substrate coated with an epoxy primer coating.

Marine surfaces have a tendency to rapidly accumulate colonizing organisms that may range from microscopic bacteria, cyanobacteria, spores of algae and unicellular eukaryotes such as diatoms, to larger larvae of invertebrates. Colonization can start within minutes to hours of immersion of the surface in water, which can be followed by the formation of a biofilm consisting of firmly attached cells. Attached algal spores or invertebrate larvae can rapidly grow into macroscopic adults. Accumulation of biomass on a ship hull is significantly detrimental to marine locomotion, causing higher hydrodynamic drag, which results in lower operational speeds and/or increased fuel consumption.

This being said, the invention also relates to a method of coating a surface of a substrate with the coating composition of the invention. The compositions disclosed herein showed resistance to the settlement of and facilitated the removal of barnacles, Ulva spores/sporelings and Navicula diatoms

The coating composition of the invention includes reactive polysiloxanes and a surfactant preferably a non-ionic surfactant. Representative siloxanes of the invention are hexamethylcyclotrisiloxane, octamethylcyclotetrasiloxane, dodecamethylcyclohexasiloxane and decamethylcyclopentasiloxane and mixtures thereof.

Typical non-ionic surfactant according to this invention is a surfactant which has an HLB value greater than 13.0, and preferably greater than 15.0. Representative emulsifiers in this category of nonionic surfactant which are solids at room temperature are: (i) Brij 700 which is a polyoxyethylene stearyl ether and a product of ICI Americas Inc. of Wilmington, Del., having an HLB value of 18.8; (ii) Mapeg® S-40K which is a polyoxyethylene monostearate and a product and trademark of PPG/Mazer of Gurnee, Ill., having an HLB value of 17.2; (iii) Macol® SA-40 which is steareth-40 and a product and trademark of PPG/Mazer of Gurnee, Ill., having an HLB value of 17.4; (iv) Triton® X-405 which is octylphenoxy polyethoxy ethanol and a product and trademark of Union Carbide Chem. & Plastics Co., Industrial Chemicals Div., Danbury, Conn., having an HLB value of 17.9; (v) Macol® SA-20 which is steareth-20 and a product and trademark of PPG/Mazer of Gurnee, Ill., having an HLB value of 15.4; and (vi) Tergitol® 15-S-20 which is a C₁₁-C₁₅ secondary alcohol ethoxylate and a product and trademark of Union Carbide Chem. & Plastics Co., Industrial Chemicals Div., Danbury, Conn., having an HLB value of 16.3.

A particular useful polysiloxane composition is SILRES® BS 1340 (by Wacker Silicones) is a nonionic, solvent-free, water dilutable emulsion of a reactive polysiloxane. The emulsion contains octamethylcyclotetrasiloxane and a branched tridecanolethoxylate.

The SILRES® BS 1340 can be used in undiluted or diluted form for coating the substrates. The emulsion has a milky white appearance, and it has a solids content of approximately 50 wt. % and a pH-Value Indicator strips 8-9 at 25° C.

The invention further relates to the use of the combination of one or more of the above polymethylcyclosiloxane components alone or in combination for providing antifouling properties.

The compositions of the invention may also include other antifoulant compounds, which are roughly divided into three groups, i.e., inorganic compounds, organometallic compounds, and metal-free organic compounds. Examples of the inorganic compounds include copper powder, copper compounds such as cuprous oxide, cuprous thiocyanate, copper carbonate, copper chloride, and copper sulfate, zinc sulfate, zinc oxide, nickel sulfate, and copper-nickel alloys.

The organometallic compounds include, for example, organocopper compounds, organonickel compounds, and organozinc compounds. Also usable are maneb, manzeb, propineb, and the like. Examples of the organocopper compounds include oxine copper, copper nonylphenol sulfonate, copper bis(ethylenediamine) bis(dodecylbenzenesulfonate), copper acetate, copper naphthenates, copper bis(pentachlorophenolate)s, and copper pyrithione. Examples of the organonickel compounds include nickel acetate and nickel dimethyldithiocarbamate. Examples of the organozinc compounds include zinc acetate, zinc carbamate, zinc dimethyldithiocarbamate, zinc pyrithione, and zinc ethylenebisdithiocarbamate.

The metal-free organic compounds include, for example, N-trihalomethylthiophthalimides, dithiocarbamic acids, N-arylmaleimides, 3-(substituted amino)-1,3-thiazolidine-2,4-diones, dithiocyano compounds, triazine compounds, and others.

Examples of the N-trihalomethylthiophthalimides include N-trichloromethylthiophthalimide and N-fluorodichloromethylthiophthalimide. Examples of the dithiocarbamic acids include bis(dimethylthiocarbamoyl) disulfide, ammonium N-methyldithiocarbamate, ammonium ethylenebis(dithiocarbamate), and milneb.

Examples of the N-arylmaleimides include N-(2,4,6-trichlorophenyl)maleimide, N-4-tolylmaleimide, N-3-chlorophenylmaleimide, N-(4-n-butylphenyl)maleimide, N-(anilinophenyl)-maleimide, and N-(2,3-xylyl)maleimide.

Examples of the 3-(substituted amino)-1,3-thiazolidine-2,4-diones include 3-benzylideneamino-1,3-thiazolidine-2,4-dione, 3-(4-methylbenzylideneamino)-1,3-thiazolidine-2,4-dione, 3-(2-hydroxybenzylideneamino)-1,3-thiazolidine-2,4-dione, 3-(4-dimethylamino-benzylideneamino)-1,3-thiazolidine-2,4-dione, and 3-(2,4-dichlorobenzylidene-amino)-1,3-thiazolidine-2,4-dione.

Examples of the dithiocyano compounds include dithiocyanomethane, dithiocyanoethane, and 2,5-dithiocyanothiophene. Examples of the triazine compounds include 2-methylthio-4-t-butylamino-6-cyclopropylamino-s-triazine.

Examples of the other metal-free organic compounds include 2,4,5,6-tetrachloroisophthalonitrile, N,N-dimethyl-N′-dichlorophenylurea, 4,5-dichloro-2-n-octylisothiazolin-3-one, N,N-dimethyl-N′-phenyl(N-fluorodichloromethylthio)sulfamide, tetramethylthiuram disulfide, 3-iodo-2-propynylbutyl carbamate, 2-(methoxycarbonylamino)benzimidazole, 2,3,5,6-tetrachloro-4-(methylsulfonyl)pyridine, diiodomethyl p-tolylsulfone, phenyl(bispyridine)bismuth dichloride, 2-(4-thiazolyl)benzimidazole, and pyridine triphenylborane.

At least one member selected from such various antifoulants is used in the present invention in an amount of usually from 0.1 to 80% by weight, preferably from 1 to 60% by weight, based on the total amount of all other ingredients in the coating composition. If the amount of the antifoulant is too small (i.e., less than 0.1% by weight), an antifouling effect cannot be expected. If the amount thereof is too large (i.e., more than 80% by weight), the coating film formed from the coating composition is apt to develop defects such as cracks and peeling and be less effective in fouling prevention.

Various additive ingredients may be suitably incorporated into the coating composition of the present invention thus prepared. Examples of the optional ingredients include colorants such as pigments, e.g., red iron oxide, zinc oxide, and talc, and dyes, dehumidifiers, and additives ordinarily employed in paints, such as antisagging agents, plasticizers, e.g., chlorinated paraffins, dioctyl phthalate, and tricresyl phosphate, ultraviolet absorbers, e.g., benzophenone compounds and benzotriazole compounds, antiflooding agents, antisettling agents, antifoaming agents, silanols, polysiloxanes, and alkoxysilanes.

The compositions also contain rheology additives generally suitable for increasing system viscosity to improve storage stability, processability, and achieving greater film thicknesses. The properties or type of rheology additive (pseudoplastic/thixotropic) is used to increase viscosity or film thickness can be modified with respect to the intended use. Rheology additives based on phyllosilicates for aqueous systems are particularly suitable. The rheology additive may be added at levels of 1-20%.

For forming an antifouling coating film from the coating composition of the present invention on the surface of a structure to be submerged in seawater, use may be made of a method in which the coating composition is applied on the surface in a suitable manner and the solvent is removed by evaporation at ordinary temperature or with heating. By this method, a dry coating film can be easily formed on the surface of the structure.

The methods for inhibiting fouling of an underwater marine structure use the marine coating compositions and marine coatings described above. Further, these compositions can be effective for minimizing fouling of underwater marine structures from the fouling organisms described above.

The composition of the present invention is applied via a method, but not limited to, dip coating, spray coating or flow coating. For example, they can be deposited via an electrodeposition technique such as electrophoretic deposition or electrobrushing. They can also be applied by conventional means such as brushes or rollers very well known in the paint industry.

The term “applying” is used in its normal meaning within the paint industry. Thus, “applying” is conducted by means of any conventional means, e.g. by brush, by roller, by spraying, by dipping, etc. The commercially most interesting way of “applying” the coating composition is by spraying. Hence, the coating composition is preferably sprayable. Spraying is effected by means of conventional spraying equipment known to the person skilled in the art.

The coating is typically applied in a dry film thickness of 50-600 μm, such as 50-500 μm, e.g. 75-400 μm, or 20-100 μm.

The antifouling coating composition according to the present invention is excellent in long-term storage stability (in particular, less increase in its viscosity during long-term storage) and gives a coating film excellent in long-term antifouling properties (in particular static antifouling properties) and long-term water resistance (long-term mechanical properties: adhesion, abrasion resistance, crack resistance, and appearance properties such as fracture, of a coating film when immersed in water, particularly seawater), with good balance. The antifouling coating film and the antifouling substrate according to the present invention exhibit excellent long-term antifouling properties and long-term water resistance (long-term mechanical properties) with good balance. Furthermore, the method for producing the antifouling substrate according to the present invention can provide an antifouling substrate exhibiting excellent long-term antifouling properties and long-term water resistance.

The antifouling coating film of the present invention is prepared by letting the antifouling coating composition of the present invention dry naturally or subjecting the antifouling coating composition of the present invention to drying means such as a heater, to thereby cure the composition.

The antifouling substrate of the present invention is formed by coating a substrate (target, material to be coated) with the antifouling coating composition of the present invention by coating means such as an air spray, an airless spray, a brush and a roller, or by impregnating a substrate with the antifouling coating composition of the present invention, and subjecting the coating composition, which is used to coat or impregnate the substrate, to, for example, natural drying (temperature of about room temperature) or drying means such as a heater, to dry and cure the composition to thereby form the antifouling coating film on the substrate.

The substrate used herein, which is not particularly limited, is preferably a substrate contacting with seawater or fresh water. Specific examples thereof include underwater structures such as supply and exhaust ports of various power plants (thermal power plants and nuclear power plants), coastal roads, undersea tunnels, harbor facilities, and sludge-diffusion prevention films employed for various ocean/river civil engineering works such as canals and water channels; ships such as FRP ship (particularly, a part of a ship ranging from its waterline part to its ship bottom); and fishing materials such as fishing gear such as rope and fishing nets, floats and buoys.

Examples of materials for these substrates, particularly for ships, are steel, aluminum and wood. Examples of materials for fishing nets are natural or synthetic fibers. Examples of materials for floats and buoys are synthetic resins. The material of the substrate is not particularly limited as long as antifouling properties and the like in water are required for the substrate.

In the case of the surface of these substrates, particularly that of a ship bottom and the like, usually, a steel-made substrate surface is under-coated with a primer such as an anticorrosive coating material to give a primer-treated substrate, and the surface of the primer-treated substrate surface is coated by the method as described above one time or plural times with the antifouling coating composition of the present invention (antifouling paint). Then, the antifouling coating composition used for coating or impregnating (in particular when a substrate is fishing net or the like) is cured to form an antifouling coating film. As a result, the antifouling coating film is provided which is excellent in properties preventing the adherence of aquatic creatures such as sea lettuce, barnacle, green layer, serpula, oyster and bryozoans for a long term (antifouling properties, particularly static antifouling properties); and particularly when the antifouling coating film may optionally contain other antifouling component (for example, copper or copper compounds and organic antifouling agents), the antifouling component can be gradually released over a long period of time.

When the substrate is a ship (particularly its bottom), an underwater structure or the like (generally, the substrate surface may be primer-treated or have a layer formed from any of epoxy resins, vinyl resin-based paints, acrylic resin-based paints and urethane resin-based paints), such a substrate surface is coated with the antifouling coating composition plural times (thick-coating: thickness of the film dried: about 100 to 600 μm), and thereby the resultant antifouling substrate exhibits excellent antifouling properties as well as appropriate plasticity and excellent crack resistance with good balance.

Regarding the production of the antifouling substrate, when the substrate is, for example, a steel plate or fishing net with a deteriorated antifouling coating film, the substrate surface may be directly coated with the antifouling coating composition of the present invention, or may be directly impregnated with the antifouling coating composition of the present invention (when the substrate is fishing net or the like). When the substrate is made of a steel, the substrate surface may be previously coated with a base material such as an anticorrosive and a primer to form a base layer, and then the surface of the base layer may be coated with the coating composition of the present invention. For the purpose of repairing, the antifouling coating film of the present invention may further be formed on the surface of a substrate on which the antifouling coating film of the present invention or a conventional antifouling coating film has been formed.

The thickness of the antifouling coating film, which is not particularly limited, is for example about 30 to 250 μm per coating operation when the substrate is a ship or an underwater structure.

As described above, the underwater structure having the antifouling coating film of the present invention can prevent aquatic creatures from adhering thereto over a long period of time, and as a result thereof, the underwater structure can maintain its functions over a long period of time. The fishing net having the antifouling coating film of the present invention has less possibility of environmental pollution, and is prevented from clogging as a result of the prevention of the adherence of aquatic creatures.

### EXAMPLES

The compositions of the invention are illustrated by the following examples, which are merely indicative of the nature of the present invention, and should not be construed as limiting the scope of the invention, nor of the appended claims, in any manner.

### Example I

| Component | Parts by weight |
|---|---|
| Tridecanolethoxylate, branched | 10 |
| Octamethyl cyclotetrasiloxane | 40 |
| Water | 50 |
| Total = | 100 |

### Example II

| Component | Parts by weight |
|---|---|
| Tridecanolethoxylate, branched | 5 |
| Octamethyl cyclotetrasiloxane | 45 |
| Water | 50 |
| Total = | 100 |

### Example III

| Component | Parts by weight |
|---|---|
| Tridecanolethoxylate, branched | 3 |
| Octamethyl cyclotetrasiloxane | 47 |
| Water | 50 |
| Total = | 100 |

### Example IV

| Component | Parts by weight |
|---|---|
| Tridecanolethoxylate, branched | 3 |
| Octamethyl cyclotetrasiloxane | 47 |
| Water | 50 |
| Total = | 100 |

### Example V

| Component | Parts by weight |
|---|---|
| steareth-20 | 3 |
| Octamethyl cyclotetrasiloxane | 47 |
| Water | 50 |
| Total = | 100 |

### Example VI

| Component | Parts by weight |
|---|---|
| steareth-20 | 5 |
| Octamethyl cyclotetrasiloxane | 50 |
| Water | 50 |
| Total = | 100 |

### Example VII

| Component | Parts by weight |
|---|---|
| steareth-20 | 5 |
| Octamethyl cyclotetrasiloxane | 45 |
| hexamethylcyclotrisiloxane | 5 |
| Water | 50 |
| Total = | 100 |

### Example VIII

| Component | Parts by weight |
|---|---|
| Tridecanolethoxylate, branched | 3 |
| Octamethyl cyclotetrasiloxane | 45 |
| Activated phyllosilicate | 2 |
| Water | 50 |
| Total = | 100 |

### Example IX

| Component | Parts by weight |
|---|---|
| steareth-20 | 3 |
| Octamethyl cyclotetrasiloxane | 45 |
| Activated phyllosilicate | 2 |
| Water | 50 |
| Total = | 100 |

### Example X

| Component | Parts by weight |
|---|---|
| SILRES ® BS 1340 (by Wacker) | 48 |
| Activated phyllosilicate | 2 |
| Water | 50 |
| Total = | 100 |

### Example XI

| Component | Parts by weight |
|---|---|
| SILRES ® BS 1340 (by Wacker) | 50 |
| Activated phyllosilicate | 2 |
| Water | 48 |
| Total = | 100 |

### Example XII

| Component | Parts by weight |
|---|---|
| SILRES ® BS 1340 (by Wacker) | 55 |
| Activated phyllosilicate | 2 |
| Water | 43 |
| Total = | 100 |

### Example XIII

| Component | Parts by weight |
|---|---|
| SILRES ® BS 1340 (by Wacker) | 50 |
| Activated phyllosilicate | 2 |
| copper naphthenates | 2 |
| Water | 46 |
| Total = | 100 |

### Example XIV

| Component | Parts by weight |
|---|---|
| SILRES ® BS 1340 (by Wacker) | 50 |
| Water | 50 |
| Total = | 100 |

### Example XIV

The formulations of the invention were applied to the hull of a steel boat which was immersed in the ocean at a temperature of from 14° to 17° C. for one year. Upon inspection, the coated areas where formulas were applied were fouled with marine life, algae, and barnacles but to a minimal extent.

The compositions of the invention may be applied by spraying, roller brushing or by brushing using conventional known methods in the art. For example, for forming an antifouling coating film from the coating composition of the present invention on the surface of a structure to be submerged in seawater, use may be made of a method in which the coating composition is applied on the surface in a suitable manner and the solvent is removed by evaporation at ordinary temperature or with heating. By this method, a dry coating film can be easily formed on the surface of the structure.

The compositions may also optionally include other carrier solvents including aliphatic and aromatic hydrocarbons, terpenes, alcohols, esters, ethers, ketones, ether-alcohols, halogenated hydrocarbons, other volatile silicones and water. In addition, the compositions can be blended with any other coating composition such as paints and applied to the substrate.

The coating composition can be applied directly or indirectly to any substrate including metal, wood or plastics such as fiberglass, epoxy and the like. Good performance is achieved when the coating is applied to a precoated substrate where the precoating is a smooth finish obtained with a polyurethane or epoxy coating.

All patents, patent applications and publications cited in this application including all cited references in those applications, are hereby incorporated by reference in their entirety for all purposes to the same extent as if each individual patent, patent application or publication were so individually denoted.

While the many embodiments of the invention have been disclosed above and include presently preferred embodiments, many other embodiments and variations are possible within the scope of the present disclosure and in the appended claims that follow. Accordingly, the details of the preferred embodiments and examples provided are not to be construed as limiting. It is to be understood that the terms used herein are merely descriptive rather than limiting and that various changes, numerous equivalents may be made without departing from the spirit or scope of the claimed invention.

What is claimed is:

1. A marine antifouling coating emulsion composition comprising:
(a) 1 to 50% by weight of a cylic volatile polymethycyclosiloxane selected from the group consisting of hexamethylcyclotrisiloxane, octamethylcyclotetrasiloxane, decamethylcyclopentasiloxane and dodecamethylcyclohexasiloxane and mixtures thereof; and
(b) 1 to 20% of a surfactant selected from the group consisting of polyoxyethylene monostearate, steareth-40, octylphenoxy polyethoxyethanol, steareth-20, and a C₁₁-C₁₅ secondary alcohol ethoxylate and mixtures thereof; and
(c) the balance water.

2. A method of inhibiting the settlement of barnacles on a marine surface or article exposed to settlement thereof comprising coating said surface with the composition of claim 1.

3. A method of inhibiting the growth of barnacles and other marine life on the hulls of boats, the method comprising the step of coating said hulls with the composition of claim 1.

4. A method for controlling fouling by barnacles, hydroids, and algae of an underwater surface of a marine structure in salt water comprising the steps of applying a coating comprising the composition of claim 1.

5. An antifouling coating film formed by curing the antifouling coating composition according to claim 1.

6. An antifouling substrate formed by a method comprising: coating or impregnating a substrate with the antifouling coating composition according to claim 1; and curing the coating composition, to thereby form an antifouling coating film on the substrate.

7. The substrate according to claim 6, wherein the substrate is in contact with seawater or fresh water.

8. The substrate according to claim 6, wherein the substrate is at least one selected from the group consisting of an underwater structure, a ship and a fishing gear.

9. A method for producing an antifouling substrate, comprising: coating or impregnating a substrate with the antifouling coating composition according to claim 1; and curing the coating composition, to thereby form an antifouling coating film on the substrate.

10. The composition of claim 1, further containing a rheology modifier.

11. The composition of claim 10, wherein said rheology modifier is an activated phyllosilicate.
